(19) United States
(12) Patent Application Publication
(10) Pub. No.: US 2015/0231874 A1
(43) Pub. Date: Aug. 20, 2015

(54) FORMING CONDUCTIVE PATTERNS USING INK COMPRISING METAL NANOPARTICLES AND NANOWIRES

(71) Applicant: UNIPIXEL DISPLAYS, INC., The Woodlands, TX (US)

(72) Inventor: Danliang Jin, The Woodlands, TX (US)

(21) Appl. No.: 14/401,209

(22) PCT Filed: Mar. 13, 2013
(86) PCT No.: PCT/US2013/030662

§ 371 Date: Nov. 14, 2014

Related U.S. Application Data
(60) Provisional application No. 61/648,966, filed on May 18, 2012.

(51) Int. Cl. B41F 5/24

(52) U.S. Cl. CPC B41F 5/24

(57) ABSTRACT

Disclosed herein are systems and methods for manufacturing a conductive pattern using ink comprising nano-catalysts such as metal nanoparticles and nanowires. The geometry of the printed pattern, nanoparticle content of the ink, and conductivity desired for the end application of the product, alone or in combination with these or other factors, may support a manufacturing process where a conductive pattern may be formed without electroless plating, without curing, or with a modified plating and/or curing procedures.

### CROSS-REFERENCE TO RELATED APPLICATIONS

This application claims priority to U.S. Provisional Application No. 61/648,966 filed May 18, 2012 entitled “METHOD OF PRINTING PATTERNS ONTO A SUBSTRATE USING METAL NANOPARTICLES AND NANOWIRES, WHEREIN THE PRINTED PATTERNS DO NOT REQUIRE ACTIVATION PROCESS FOR PLATING,” incorporated herein by reference.

### FIELD OF THE DISCLOSURE

This disclosure relates generally to flexible and printed electronics (FPE). More particularly, the present disclosure relates to a method of fabrication of microscopic conductive patterns on a flexible substrate film, whereby the flexible and transparent printed patterns do not require activation before plating.

### BACKGROUND

Devices using RF antenna as well as resistive and capacitive touch screen technologies may comprise materials that are both transparent and electrically conductive. The demand for the devices and systems that use these products is on the rise, as such, efficient, reliable, and economical systems and methods of producing these components may be increasingly desirable. The conductivity contributes to the functionality and the transparency contributes to the user experience so that the user of the device comprising the touch screen can see the information displayed on the screen and not reflection from the conductive patterns. Conventionally, Indium Tin Oxide (ITO) is used as a metal oxide for touch screen sensor applications as it is optically transparent and is conductive. ITO may be employed to make transparent conductive coatings for liquid crystal displays, flat panel displays, touch panels, solar panels and aircraft windshields.

### SUMMARY

In an embodiment, a method of forming a conductive pattern by flexographic printing using nano-catalyst ink comprises: cleaning a substrate; printing a pattern using an ink on a first side of the substrate, wherein the pattern comprises at least one line, wherein the line is 1-25 microns wide, and wherein the ink comprises a binder and a plurality of nano-catalysts comprising at least one of a plurality of nanoparticles and a plurality of nanowires, wherein the plurality of nano-catalysts formed are one of palladium-copper nano-catalysts, silver nano-catalysts, or copper nano-catalysts, and wherein the ink comprises at least 50 wt. % nano-catalysts; and curing the first pattern.

In an embodiment, a method of forming a conductive pattern by flexographic printing using nano-catalyst ink comprises: cleaning a substrate; printing a pattern using an ink on a first side of the substrate, wherein the pattern comprises at least one line, wherein the line is 1-25 microns wide, and wherein the ink comprises a binder and a plurality of nano-catalysts, wherein the plurality of nano-catalysts formed are at least one of ethylene glycol silver nano-catalysts or glucose silver nano-catalysts, and wherein the ink comprises at least 50 wt. nano-catalysts; and plating the pattern.

In an embodiment, a method of forming a conductive pattern by flexographic printing using nano-catalysts ink comprises: cleaning a substrate; and printing a pattern using an ink on a first side of the substrate, wherein the pattern comprises at least one line, wherein the line is 1-25 microns wide, and wherein the ink comprises a binder and a plurality of nano-catalysts, wherein the plurality of nano-catalysts formed are at least one of ethylene glycol copper nano-catalysts or glucose copper nano-catalysts, and wherein the ink comprises at least 50 wt. % nano-catalysts.

The foregoing has outlined rather broadly the features of the disclosure in order that the detailed description that follows may be better understood. Additional features and characteristics will be described hereinafter that form the subject of the claims. Thus, embodiments described herein comprise a combination of features and characteristics intended to address various shortcomings associated with certain prior systems and methods. The various characteristics and features described above, as well as others, will be readily apparent to those skilled in the art upon reading the following detailed description of the exemplary embodiments, and by referring to the accompanying drawings.

### BRIEF DESCRIPTION OF THE DRAWINGS

For a detailed description of the exemplary embodiments of the disclosure reference will now be made to the accompanying drawings in which:

FIG. 1 is an illustration of a system for manufacturing a high resolution conductive pattern (HRCP) according to an embodiment of the present disclosure.

FIG. 2 is an illustration of an alternate system for manufacturing a high resolution conductive pattern (HRCP) according to an embodiment of the present disclosure.

FIG. 3 is a flow chart of a method of manufacturing a high resolution conductive pattern according to an embodiment of the present disclosure.

### DETAILED DESCRIPTION

The following disclosures are incorporated by reference: U.S. Pat. No. 7,070,406 “Apparatus for embossing a flexible substrate with a pattern carried by an optically transparent compliant media,” U.S. Pat. No. 6,245,249 “Micro-structure and manufacturing method and apparatus,” US 20060134562 A1 “Method of forming micro-pattern,” U.S. Pat. No. 6,632,342 “Methods of fabricating a microstructure array,” US 20090020215 A1 “Optical Coatings with Narrow Conductive Lines,” U.S. Pat. No. 7,973,997 “Transparent structures,” and US20020142143 A1 “Laser engraved embossing roll,” and U.S. Pat. No. 5,759,473 “Method for producing an Embossing roll.”

The present disclosure relates to methods of printing high-resolution conductive patterned lines onto a flexible transparent substrate using ink compositions comprising a polymer binder and suspended metal nanoparticles and nanowires that do not require activation process before plating. Conventionally, ITO film is used for touch screens and other high resolution conductive patterns. In resistive touch screens, when a user touches the screen with a finger or a stylus, the ITO film is pushed into contact with the ITO glass producing a voltage signal allowing a processor to compute the coordinates (X and Y) of the touch event and process the appropriate response to the touch point. ITO may have availability (sourcing) and cost concerns and minor issues include average conductance relative to other materials and the films frailty. More specifically, the limited supply is exacerbated by the fact that indium is a rare earth metal that is nearly exclusively mined and produced in China. As such, exports for commercialization are controlled by the government of China and command a premium. Additionally, ITO is manufactured in a vapor deposition manufacturing process that produces fragile and relatively rigid films, that compared to copper, demonstrate poor conductance. The vapor deposition manufacturing process is expensive and cumbersome, making ITO a decreasingly popular option in the manufacture of touch screen devices. Finally, in addition to the limitation of the ITO element, electrode patterns in touch sensors using ITO may only be printed at certain dimensions or resolution, specifically only electrode pattern structures with features above 25 microns in width are supported by conventional printing technologies.

The methods described herein may simplify and optimize the manufacturing process of a touch sensor film or other high resolution conductive pattern such as an RF antenna array. By the use of ink compositions that contain suspended metal nanoparticles and nanowires for the printing of high resolution conductive patterned lines, one curing step may be reduced or eliminated from the conventional manufacturing process which may save time and have related cost savings. In some embodiments, the concentration by weight of the metal nanoparticles and nanowires in the ink used in a flexographic process or other process where lines under 25 microns wide are printed may be high enough to achieve electrical conductivity, hence, reducing or eliminating some processing steps, such as, but not limited, to curing or electroless plating. More specifically, the present disclosure relates to reducing or eliminating the use of palladium compounds within a UV curable ink composition. This reduction or elimination of the use of palladium compounds such as palladium acetate may be employed to reduce the number of manufacturing steps and increase manufacturing speed. While a manufacturing process that comprises multiple curing steps and plating for printed patterns may be appropriate for some applications, in other situations it may be prudent from a safety, environmental, or cost perspective to reduce the number of manufacturing steps required in the process and/or truncate the time it takes to perform those steps such as curing and plating.

Conventionally, to render the ITO layer unnecessary for components used in touch screen mobile devices, a roll-to-roll manufacturing method may be used. The substrate may be any material that may be used as a base on which to print integrated circuitries. The term “transparent” as used herein may refer to structures with less than 50 μm of width, preferably from 1 μm-25 μm and in further instances less than about 10 μm of width that cannot be easily detected by the naked eye at a distance of less than about 24 inches. The term may also refer to a material with more than 50% light transmission efficiency.

As previously described, this roll-to-roll manufacturing method and configuration are improvements over the conventional manufacturing techniques of ITO films, particularly with respect to cost. However, in order to further improve said method and enable a faster manufacturing process, lower production cost, and higher volume yield, the present disclosure describes modifications and improvements to the method and system for roll-to-roll manufacturing. Inks used in the roll-to-roll handling process may comprise palladium-based components that act as a catalyst for plating. It is appreciated that the products manufactured as disclosed herein are intended to be conductive, and the intent is to produce conductive patterns in the most reliable, efficient, safe, and cost-effective way possible for the particular application. In some cases, palladium may be expensive, short or unreliable in supply, and may result in the process having an extra curing step and/or using a plating process to achieve a desired conductivity of the pattern. The curing steps involved in a process may depend upon the application because of the substrate and the printed pattern itself, and both the time and intensity of a curing process that may comprise one or more treatments can adversely affect the overall product quality with respect to both the substrate and the printed pattern. For example, if over-cured by one or more curing treatments, the substrate may embrittle or become otherwise unsuitable for further processing and/or the end application. With respect to the printed pattern, if the printed pattern is over-exposed during curing, it may lose the catalytic properties needed for subsequent plating. Palladium curing may be carried out by deposition of palladium containing materials. However, at the initial stage of deposition palladium precipitates in the form of molecular domains, which are growing simultaneously in three directions with non-controllable growth; this may result in the formation of rough surfaces on the subsequent stages of deposition. Accordingly, one or more aspects of presented herein include reducing or eliminating the palladium content in ink through the use of an ink formulation containing another catalyst or metal nanoparticles and nanowires. These changes in ink composition may result in reduced curing requirements and/or plating requirements depending upon the composition of the ink. Ink as used herein may refer to a combination of monomers, oligomers or polymers, metal elements metal elements complexes or organometallics in liquid state that is discretely applied over a substrate surface. Further, as used herein ink may refer to any material which may be deposited on a surface or substrate as used in printing. Ink may refer to any state of a liquid, such as a mixture, suspension, or colloid, without limitation. In certain instance, ink may refer to solid or liquid aerosols deposited on a surface. As used herein, the term electroless plating may refer to a catalyst activated chemical technique used to deposit a layer of conductive material on to a given surface. The ink formulation disclosed herein may represent a reduction in material costs by partially or totally reducing the amount of palladium acetate within the UV curable ink composition. In some embodiments, the elimination of certain steps in the microstructure roll-to-roll manufacturing method may permit high-speed, increased volume production of high resolution conductive pattern by the means of an E-beam curing station that facilitates improved curing time of the polymer element within the ink composition.

In an embodiment, an elongated, transparent, flexible, thin substrate is placed on an unwind roll in a roll-to-roll handling process. In some embodiments, an alignment method may be used to establish and maintain the correct alignment between the flexible substrate and the roll-to-roll process so that the microscopic patterns are printed are correctly and completely translated to the substrate. In one example, an alignment method such as an alignment guide or a positioning cable may be used to maintain the right alignment of the substrate to the process in order to create the correct features. The thin, flexible substrate may be transferred via a roll-to-roll handling method from an unwind roll to a corona treatment station to remove small particles, oils, and crease on a first side of the substrate. The corona treatment station may also be used to increase the surface energy and obtain sufficient wetting and adhesion on the substrate. The corona treatment station discharges high frequency electric charges to the first surface of the substrate which forms ends and free valences. The free valences may then be able to form carbonyl groups with the atoms from the ozone created by the electric discharge, which gives the improved adhesion. Generally, the more power/electrons, the shorter the chains and the more adhesions points may lead to a higher surface energy. For a PET film as substrate, the intensity level the corona treatment station may range from about 1 W/min/m² to about 50 W/min/m², while the surface energy may range from about 20 Dynes/cm to about 95 Dynes/cm. In some embodiment, the substrate may undergo a second cleaning station that may comprise a web cleaner. A web cleaner, as used herein, may refer to any device used in web manufacturing to remove particles from a web or substrate. Subsequent to cleaning, the substrate may be printed on a first side at a printing station wherein a pattern comprising a plurality of lines of the substrate using a flexo master plate and a UV curable ink. A master plate which may also be referred to as a flexomaster or flexoplate comprises a predefined pattern which comprises a plurality of lines that are to be printed on a substrate. An anilox roll as used herein may refer to a cylinder used to provide a measured amount of ink to a printing plate. Alternatively, the term may be used to refer to any roller with a recessed or pattern on its surface used to transfer ink onto a flexoplate. Generally, as used herein the term “anilox roller” may be used along with the term “master plate” to refer to any metallic, polymeric, or composite, generally cylindrical drum having recesses or dimples in its circumferential surface for flexographic printing. In that event, the anilox roller may comprise a pattern or walls and wells forming recesses that are engraved into the roll. The engraved anilox roll may then be used to transfer ink during the printing process and the pattern is not printed on the substrate itself.

Materials that may be used for the UV curable ink may include a combination of acrylics, urethane, polymers and crosslinkable polymers. The amount of ink transferred from the master plate to the substrate may be regulated by a high precision metering system and depends on the speed of the process, ink composition and patterns shape and dimension. The machine speed may vary according to the ink composition, the required curing time, the allowed width tolerance for the high resolution lines, as well as other factors.

Conventionally, subsequent to printing the first pattern on the first side of the substrate, the substrate may be cured at a curing station by UV light wherein the UV light source initiates the polymerization of acrylic groups within the ink composition and activates the plating catalyst which conventionally may be palladium acetate. Curing as discussed herein may refer to the process of drying, solidifying or fixing any coating or ink imprint, previously applied, on a substrate. Further, as used herein curing may refer to the act of applying radiation to change at least one physical or chemical property of a material. Furthermore, curing may refer to the process of chemical or physical changes in a fluid such as ink under irradiation. The term “plating catalyst” may refer to any substance that may enable a chemical reaction in the plating process. In some compositions this substance may be contained in the printing ink. The curing speed of the acrylic element within the UV curable ink composition may affect the uniformity of the high-resolution printed lines. That is, curing of the acrylic element may occur in a very short period in order to avoid spreading of the UV curable ink across the substrate. The first UV light source may be a UVA or UVB ultraviolet light source, preferably an industrial grade UVA or UVB light source as it is desired to cure the acrylic element in a very short period of time, in the order of about 0.1 seconds to about 2.0 seconds. Although the activation of the plating catalyst within the UV curable ink composition may begin at the first UV curing station, the UV exposure time and intensity may not be enough for the complete activation or reduction of the palladium acetate element. A palladium acetate catalyst may exhibit a 2+ positive charge that is reduced to 0 or neutral before plating. As a result, in some embodiments, another curing station may be utilized after the first UV curing station. The flexible transparent substrate comprising the printed microscopic pattern on the first side may pass through a second UV curing station, whereby second UV light source may produce a redox chemical reaction that transfers two electrons (2−) to the palladium acetate element, reducing its oxidation state from 2+ to 0 or neutral. The intensity of the second UV light source may be set higher than the first UV light source. In other configurations, the second UV curing station may be substituted by a thermo-heating station that applies heat. In some embodiments, a post-thermal treatment in oven may also be used to achieve the same effect.

After the chemical reduction of the palladium acetate, the substrate with the printed microscopic pattern disposed on the first side may be exposed to an electroless plating bath wherein a layer of conductive material is deposited on the microscopic pattern. This electroless plating process does not require the application of an electrical current and it only plates the patterned areas containing plating catalysts that were previously printed and activated by the exposition to UV radiation during the curing process. The plating bath may be copper and further comprise strong reducing agents in it, such as formaldehyde, borohydride which cause the plating to occur. The plating thickness may be more uniform as compared to electroplating due to the absence of electric fields. Although electroless plating may be more time consuming than electrolytic plating, electroless plating may be well suited for parts with complex geometries and/or many fine features. After the plating step, plated electrode pattern structures that are conductive are formed on top of the first side of the flexible transparent substrate. In some embodiments, subsequent to plating, the substrate may be cleaned by water at room temperature and dried by air. Finally after cleaning and drying, the transparent and the flexible substrate with the plated electrode pattern are taken up by a wind-up roll. In some cases, depending upon the cost, environmental impact, equipment availability, volume, and product design, the process used to form high resolution conductive patterns may not comprise all of the conventional steps discussed above and may in fact be able to proceed with fewer steps or truncated steps, steps such as curing and plating. In some of these cases, it may be possible to accomplish this modified processing path by choosing an ink formulation that requires less or no curing and/or plating in order to become conductive.

Disclosed herein are multiple methods of forming metal nanoparticles and nanowires within a UV curable ink composition that may behave as plating seeds and may eliminate the catalyst metal activation step. In some applications, depending upon cost, volume, and available facilities, it may be desirable to eliminate or reduce one or more processing steps such as curing or plating in order to produce a conductive pattern or patterns on a substrate. In that event, method may be used that may not require the use of a second UV curing station or other thermal activation as may be seen in conventional processing. Specifically, UV curable ink compositions may comprise a polymer liquid solution that may be referred to as a binder. This binder may comprise suspended metal nanoparticles and nanowires that are already reduced or in a neutral state, so there may not be a need for UV or thermal activation in the manufacturing process. In some embodiments, the concentration by weight of the metal nanoparticles and nanowires within the ink composition in each of the 3 methods may vary from about 0.2 wt. % to about 70 wt. %.

In one embodiment, the concentration of palladium acetate within the UV curable ink used in the microstructure roll-to-roll manufacturing method may be reduced by a 1:1 ratio (or 50%) of Palladium-Copper (Pd—Cu) alloy. A microstructural pattern as used herein may be any conductive or non-conductive material patterned, plated, deposited or printed onto a substrate surface. As used herein, each line of the plurality of lines of the patterned material has a width or lateral measurement in the plane of the substrate surface of less than about 1 μm-50 μm. This method can reduce the palladium amount into half of the original method. However, a curing step and/or an electroless plating bath may still be part of the process. In this example, palladium-copper metal nanoparticles are prepared by heating mixtures of palladium acetate and copper acetate hydrate in 2-ethoxyethanol to reflux in the presence of polyvinylpyrrolidone (PVP) with a 40,000 molecular weight. Heating is performed at about a temperature of approximately 135° C. and for a period of about 2 hours. In one example preparation of a 50/50 Pd/Cu colloid, 30 mL of 2-ethoxyethanol containing 75 mmol each of copper and palladium acetates and 1.66 g of PVP is refluxed for a period of about 2 hours. The resulting dark brown solution was filtered through a 0.2 μm Teflon filter and stored under nitrogen. The resulting palladium-copper metal nanoparticle size is about 4 nm. In other embodiments, the nanoparticle size may range from 3 nm-200 nm.

Silver nanoparticles can also be purchased from various commercial sources or the nanoparticles can be manufactured. In an embodiment where the nanoparticles are synthesized, the UV curable ink used in the printing of a pattern with microscopic features over the substrate is composed of silver nanoparticles and nanowires suspended in liquid polymer solution. In some embodiments, the use of palladium acetate may be reduced to 0% within the UV curable ink composition. However, electroless plating bath may still be used if the concentration by weight of silver metal nanoparticles and nanowires within the ink composition is not high enough to achieve electrical conductivity. In this embodiment, a synthesis approach may be used for the preparation of silver (Ag) nanoparticles within a polymer solution. Specifically, two colloidal forms of silver nanoparticles are prepared by one-step synthetic method using ethylene glycol and glucose as reducing agents. Uniform silver nanoparticles are obtained by reduction of silver nitrate (AgNO₃) within a temperature range from about 50° C. to about 70° C. under atmospheric pressure. Polyvinylpyrrolidone (PVP) may be used as stabilizer during the synthesis. Ethylene glycol silver nanoparticles are synthesized by dissolving 157 mg of AgNO₃ and 5 g of PVP in 100 ml of 99.9% ethylene glycol. For the preparation of glucose silver nanoparticles, 157 mg of AgNO₃ and 5 g of PVP are dissolved in 100 ml of 40% (w/w) of glucose syrup. In some embodiments, to promote completion of the reaction and to ensure all the ionic silver has been converted to nanoparticles, 5 ml of sodium chloride (NaCl) are added to the samples. Creation of turbidity in the reaction solution indicates the presence of ionic silver while a clear solution confirms completion of the reaction. The nanoparticle solution is stable after three months checking the ultraviolet-visible (“uv-vis”) spectrum. The resulting silver metal nanoparticle size may range from about 10 nm to about 100 nm, with the highest population of particles being approximately 50 nm in diameter.

In an alternate embodiment, the palladium acetate catalyst within the UV curable ink used for the printing of a microscopic pattern over a substrate may be substituted by copper (Cu) nanoparticles and nanowires that may not require activation and curing therefore may be a reduced part of the manufacturing process or absent from the manufacturing process. As discussed above with respect to the silver nanoparticles, the use of copper metal nanoparticles and nanowires may completely eliminate the need of palladium acetate within the ink composition. However, an electroless plating bath may still be employed if the concentration by weight of copper metal nanoparticles and nanowires within the ink composition is not high enough to achieve electrical conductivity. In an embodiment, copper (Cu) metal nanoparticles may be formed by irradiation using a 253.7 nm light from a low pressure Hg-arc lamp in the presence of a protective agent Polyvinylpyrrolidone (PVP). Specifically, the de-aerated aqueous solution of copper sulphate (CuSO₄) with a concentration of 1×10⁻⁴ mol/dm³ containing PVP within a concentration by weight of 0.5% and benzophenone (BP) with a concentration of 1×10⁻⁴ mol/dm³ was placed in a rectangular quartz cuvette of 114 cm in size. The power intensity of the 253.7 nm UV light is about 200 W using low pressure Hg lamps (Rayonet Photochemical Reactor) at an ambient temperature. The cell is placed in the reactor and a 4-4.5 ml solution is put in it for photolysis. The role of a photo-sensitizer, BP, in the formation of copper metal particles was studied. The copper metal nanoparticles are characterized by their absorption maxima and transmission electron micrographs. The resulting copper metal nanoparticle size may range from about 15 nm to about 100 nm.

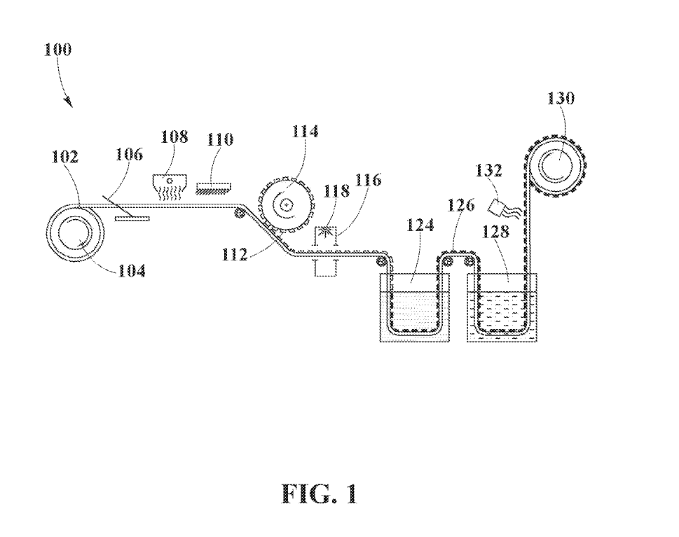

FIG. 1 is an illustration of a system for manufacturing a high resolution conductive pattern (HRCP) according to an embodiment of the present disclosure. The speed of the system depicted in FIG. 1 may vary from 20 FPM to 750 FPM, while 50 FPM to 200 FPM may be preferable for most applications. It is appreciated that the plurality of nano-size solids introduced to the ink may be described interchangeably as either nanoparticles or nanowires and may be collectively referred to as nano-catalysts. Nanoparticles are any particles where all dimensions are between 1 nm-200 nm; nanoparticles may be regularly or irregularly sized. Nanowires are particles that have a diameter from 1 nm-200 nm but where there is no restriction on the length of the wire. This special formulation of UV curable ink containing metal nanoparticles and nanowires does not require activation since the metal nanoparticles and nanowires are already reduced or are in metal state. The substrate 102 is loaded on an unwind roll 104 and, in some embodiments, an alignment station 106 may be used to align the substrate 102. In general, materials that may be used for the flexible transparent substrate include plastic films such as polyesters, polyimides, polycarbonates and polyacrylates. Specifically, suitable materials for the flexible transparent substrate may include the DuPont/Teijin Melinex 454 and Dupont/Teijin Melinex ST505, the latter being a heat stabilized film specially designed for processes where heat treatment is involved. In some embodiments, the substrate may have a thickness between 5 and 500 microns, with a preferred thickness between 100 microns and 200 microns. For high definition applications, the surface of the flexible transparent substrate film may be microscopically smooth, with a thickness ranging from 1 micron to 1 millimeter.

The substrate 102 may undergo a web cleaning at a first cleaning station 108 and a drying at drying station 110 prior to printing at first printing station 114. However, the first UV curing station 116 may be still used to cure the acrylic monomer element and avoid spreading of the UV curable ink across the substrate 102. In an embodiment, the UV-curable ink may have a viscosity between 200 cps-15,000 cps. In some embodiments, the UV curable ink may be composed of an acrylic monomer or polymer element within a concentration by weight of 20 to 99% and which can be obtained from commercial providers such as Sartomer, Radcuer, and Double Bond among others; a photo-initiator or thermo-initiator element within a concentration by weight of 1 to 10% by weight supplied by Ciba Geigy; and a Palladium acetate element within a concentration by weight ranging from 0.1 and 15%, with 3 to 5% being operating range. Certain crosslinkable mechanisms may not use any photo-initiator or other activation agent. In one embodiment, to reduce the content of palladium acetate in the ink, the formulation of UV curable ink is composed of metal nanoparticles and nanowires suspended in a UV curable resin liquid solution that includes a photo-initiator when it is necessary and monomer in liquid state. A pattern comprising a plurality of lines may be printed at first printing station 114. Each line of the plurality of lines of the printed pattern may have a width between 1 micron-20 microns and a thickness from 50-2000 nm. When first UV light source 118 from the first UV curing station 116 shines into the UV curable resin, the photo-initiator absorbs the UV light and discomposes, generating free radicals that react with the monomer element, and consequently triggering the polymerization that solidifies the UV curable ink. Preferably, the first UV light source has a wavelength from about 280 nm to about 480 nm, with a target intensity ranging from about 0.5 mW/cm² to about 50 mW/cm². If a thermal cure is used instead of or in addition to the UV cure at first UV curing station 116, the cure may be performed within a temperature range of about 20° C. to about 85° C. for metal catalyst activation

After polymerization, the solidified UV curable ink containing metal nanoparticles and nanowires may be ready for plating without the need for further activation. The rest of the process steps before and after curing may proceed as discussed above, including electroless plating bath at plating station 124 since the concentration of metal electrical conductivity. At plating station 124, the conductive material is produced from certain metal ions in a liquid state at a temperature range between about 20° C. and about 90° C., alternatively 40° C. to 50° C. The deposition rate may be 10-150 nanometers per minute and within a thickness of about 0.001 microns to about 100 microns, depending on the speed of the web and according to the specifications of the applications. Subsequent to plating, the plated pattern 126 on the substrate 102 may be cleaned at another cleaning station 128 by water at room temperature and dried at block 132 by air at a flow rate of about 20 feet per minute and at room or elevated temperature before being wound/disposed on to a winding roll 130. In some embodiments of the conventional process, a passivation step at room temperature between 20° C. and 30° C. in a pattern spray may be added after the drying station 132 to prevent any undesired chemical reaction between copper and water or oxygen.

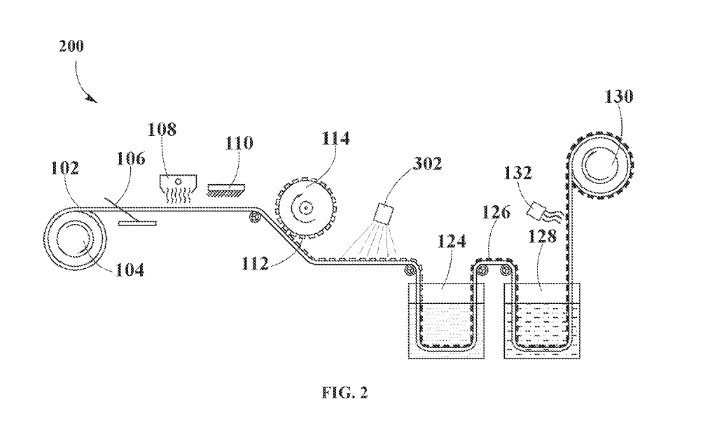

FIG. 2 is an illustration of an alternate system for manufacturing a high resolution conductive pattern (HRCP) according to an embodiment of the present disclosure. In FIG. 2, all processing steps of a system 200 may be the same as used in the system 100 in FIG. 1, except curing. The configuration depicted in FIG. 2 may be used with ink compositions containing metal nanoparticles and nanowires, for example, silver and copper nanoparticles respectively, whereas the configuration depicted in FIG. 1 may be used for ink compositions that contain a palladium catalyst. The system 200 comprises an unwind roll 104, a substrate 102, an alignment station 108, a cleaning station 108, a drying station 110, and a master plate 114 that may operate in the same way as discussed with respect to FIG. 1. The e-beam curing at e-beam curing station 302 may be performed as discussed below prior to plating at a plating station 124 to form a plated pattern 126, as discussed above in FIG. 1. Subsequent to plating, the plated pattern 126 on the substrate 102 may be cleaned at another cleaning station 128 by water at room temperature and dried at block 132 by air at a flow rate of about 20 feet per minute and at room or elevated temperature before being wound/disposed on to a winding roll 130.

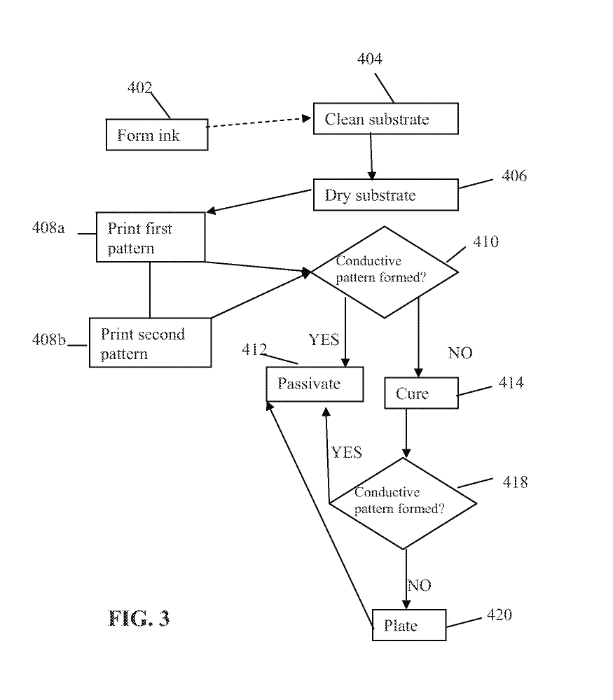

Referring to FIG. 2, microscopic pattern 112 is imprinted by the master plate 114 over the transparent flexible substrate 102 using an ink composition that contains any of the metal nanoparticles and nanowires. The e-beam curable ink used at e-beam curing station 302 does not require a photo-initiator, but rather uses the component of the ink comprising acrylic monomer liquid solution containing silver (Ag) or copper (Cu) metal nanoparticles and nanowires. At the e-beam curing station 302, an electron discharge is applied that reacts with the acrylic monomer in the ink, forming free radicals that trigger the polymerization of the e-beam curable ink, solidifying the printed microscopic pattern 112 in whole or in part. The electron discharge applied at e-beam curing station 302 does not affect the silver (Ag) or copper (Cu) metal nanoparticles and nanowires suspended in the acrylic monomer solution because silver (Ag) or copper (Cu) metal nanoparticles and nanowires described above already exhibit a reduced or metal state and cannot gain any electrons. The e-beam doses applied at curing station 302 to the printed microscopic pattern 112 may range from about 0.5 MRads to about 5 MRads for a very short period of time of about 0.01 seconds to about 2 seconds. The curing speed using the e-beam curing station 302 is significantly faster than the first UV curing station 116, 500 FPM compared to 200 FPM respectively. As a result of faster curing, the manufacturing speed of microstructure roll-to-roll manufacturing method 100 depicted in FIG. 2 may also be significantly faster than the configuration of the microstructure roll-to-roll manufacturing method 100 shown in FIG. 3.

In an embodiment, for example, using the methods shown in FIG. 1 and FIG. 2, an ink that may comprise silver or copper metal nanoparticles and nanowires within a weight concentration from about 50% to about 70% is used in the printing process at printing station 114. The use of silver or copper metal nanoparticles and nanowires within an increased weight concentration above 50% may further optimize the methods described in FIG. 1 and FIG. 2 by reducing or eliminating the need of electroless plating bath 124. In one example, a microscopic pattern 112 is printed on flexible transparent substrate 102 using an ink composition containing silver or copper metal nanoparticles and nanowires within a concentration above 50% may be exhibit enough electrical conductivity and may not require electroless plating bath 124. The resistivity of the microscopic pattern 112 that was printed using an ink with a concentration of silver or copper metal nanoparticles and nanowires above 50% may vary from about 0.0015 micro ohms to up to 10 kilo-ohms, depending on the ink composition and processing.

An alternative synthesis approach may be used for the preparation of silver (Ag) nanoparticles and nanowires within an acrylic solution as described above. In this example, a plurality of silver metal nanoparticles and nanowires are prepared by photo reduction of silver nitrate (AgNO₃) with 254 nm UV light in the presence of PVP. The PVP concentration may affect the particle size, an affect that may be observed by reviewing the uv-vis absorption peak, as well as the rate of the photo-reduction process. In an embodiment, the average silver metal nanoparticle or nanowire size may range from about 1 nm-200 nm, and the corresponding uv-vis absorption peak position may be from 404-418 nm in 0.25 wt. %-1.0 wt. % of PVP. It is appreciated that a high boiling point of solvent may lead to smaller particle size. The rate of the photo reduction process may increase with the PVP concentration. As may be observed by X-ray photoelectron spectroscopic studies, the polymer interacts with silver metal nanoparticles and nanowires through the oxygen atom in the >C═O group.

In another embodiment, another synthesis approach may be used for the preparation of silver (Ag) nanoparticles and nanowires within an acrylic solution as described above. In this procedure, the silver metal nanoparticles and nanowires are prepared by dissolving 2.5×10-6 mol PVP and 3.0×10-4 mol AgNO₃ in 4 ml ethanol or ethoxyethanol in a 50 ml Pyrex flask to obtain a homogeneous reaction mixture. In this embodiment, this may be achieved by refluxing in anhydrous ethoxyethanol at 130° C. in the presence of PVP.

Turning to FIG. 3, FIG. 3 is a flow chart of a method of manufacturing a high resolution conductive pattern according to an embodiment of the present disclosure. At block 402, an ink is formed comprising a plurality of palladium-copper, silver, or copper nanowires or nanoparticles. It is appreciated that the ink formed at block 402 may be formed prior to the roll-to-roll manufacturing process that begins at block 404 where the substrate is cleaned and then dried at block 406. At block 408a, a first pattern is printed on the substrate and at block 408b a second pattern may be printed on the substrate. While not pictured in FIGS. 1 and 2, the printing station 114 may comprise a plurality of printing rollers and flexomasters used to print a pattern on each side of the substrate, or two patterns on a single side of the substrate which are later assembled. In another embodiment, the printing station 114 may print patterns on two different substrates wherein those substrates are later assembled. The pattern(s) printed at blocks 408a and 408b may be printed using an ink comprising a plurality of nanoparticles in a flexographic printing process. Each line of the plurality of lines that comprise the first and/or second patterns is less than 25 microns wide, and may range from 1-25 microns wide. As discussed above, depending on the nanoparticle content (wt. %) of the ink, the pattern may be conductive as-printed. At block 410, if a conductive pattern or patterns are formed by printing, the substrate may then be passivated at block 412.

In an embodiment, if at block 410 a conductive pattern is not formed, the pattern may be cured at block 414 by ultraviolet light or e-beam. In an embodiment, the curing at block 414 is a single cure, wherein additional curing steps are not used to achieve the desired conductivity of the pattern or patterns printed at blocks 408a and 408b. This embodiment may be referred to as a single curing, and is in contrast to a multi-curing process that may be used if the first curing at block 414 does not sufficiently cure the pattern or patterns formed at blocks 408a and/or 408b. This process may comprise subsequent curing at blocks 414 or other processing as appropriate. If at block 418 a conductive pattern is not formed after curing, the pattern may be plated at block 420 and may be subsequently passivated at block 412. If at block 418 the pattern is conductive after curing, the pattern may be passivated at block 412. As discussed above, the conductivity of the pattern at various stages in the process may depend in part on the type of ink used, the content (wt. %) of the nanoparticles in the ink, the dimensions of the pattern, and the desired conductivity and/or end application.

While exemplary embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the examples disclosed herein are possible and are within the scope of the invention. Accordingly, the scope of protection is not limited by the description set out above, but is only limited by the claims which follow, that scope including all equivalents of the subject matter of the claims.

What is claimed:

1. A method of forming a conductive pattern by flexographic printing using nano-catalyst ink comprising:
cleaning a substrate;
printing a pattern using an ink on a first side of the substrate, wherein the pattern comprises at least one line, wherein the line is 1-25 microns wide, and wherein the ink comprises a binder and a plurality of nano-catalysts comprising at least one of a plurality of nanoparticles and a plurality of nanowires, wherein the plurality of nano-catalysts formed are one of palladium-copper nano-catalysts, silver nano-catalysts, or copper nano-catalysts, and wherein the ink comprises at least 50 wt. % nano-catalysts; and
curing the first pattern.

2. The method of claim 1, further comprising plating the first pattern by disposing a conductive material on the pattern, wherein the conductive material is one of copper (Cu), silver (Ag), nickel (Ni), tin (Sn), zinc (Zn), or gold (Au).

3. The method of claim 1, wherein each nanoparticle of the plurality of nanoparticles are from 3 nm-200 nm in diameter, and wherein each nanowire of the plurality of nanowires are from 1 nm-200 nm in width.

4. The method of claim 2, further comprising, prior to plating the first pattern, printing a second pattern on a second side of the substrate opposite of the first pattern.

5. The method of claim 4, wherein the second pattern is one of a plurality of loops or a second plurality of lines, and the method further comprises plating the second pattern concurrently with plating the first pattern.

6. The method of claim 1, wherein curing uses at least one of ultraviolet or e-beam curing.

7. The method of claim 1, wherein, subsequent to curing, the first pattern is conductive, wherein the curing is a single curing.

8. A method of forming a conductive pattern by flexographic printing using nano-catalyst ink comprising:
cleaning a substrate;
printing a pattern using an ink on a first side of the substrate, wherein the pattern comprises at least one line, wherein the line is 1-25 microns wide, and wherein the ink comprises a binder and a plurality of nano-catalysts, wherein the plurality of nano-catalysts formed are at least one of ethylene glycol silver nano-catalysts or glucose silver nano-catalysts, and wherein the ink comprises at least 50 wt % nano-catalysts; and
plating the pattern.

9. The method of claim 8, further comprising plating the pattern by disposing a conductive material on the pattern, wherein the conductive material is one of copper (Cu), silver (Ag), nickel (Ni), tin (Sn), zinc (Zn), or gold (Au).

10. The method of claim 8, further comprising curing the pattern prior to plating the pattern, wherein curing comprises at least one of ultraviolet or e-beam curing.

11. The method of claim 10, wherein, subsequent to curing, the first pattern is conductive, wherein the curing is a single curing.

12. The method of claim 8, wherein the ink comprises 50 wt. %-70 wt. % nano-catalysts.

13. The method of claim 8, wherein a resistivity of the printed pattern is 0.0015 micro-ohms-10 kilo-ohms.

14. A method of forming a conductive pattern by flexographic printing using nano-catalysts ink comprising:
cleaning a substrate; and
printing a pattern using an ink on a first side of the substrate, wherein the pattern comprises at least one line, wherein the line is 1-25 microns wide, and wherein the ink comprises a binder and a plurality of nano-catalysts, wherein the plurality of nano-catalysts formed are at least one of ethylene glycol copper nano-catalysts or glucose copper nano-catalysts, and wherein the ink comprises at least 50 wt % nano-catalysts.

15. The method of claim 14, further comprising curing the pattern wherein, subsequent to curing, the first pattern is conductive, wherein the curing is a single curing.

16. The method of claim 14, wherein the ink comprises 50 wt. %-70 wt. % nano-catalysts.

17. The method of claim 14, wherein a resistivity of the printed pattern is 0.0015 micro-ohms-10 kilo-ohms.

18. The method of claim 14, further comprising plating the pattern.

19. The method of claim 18, wherein plating the pattern comprises disposing a conductive material on the pattern, wherein the conductive material is one of copper (Cu), silver (Ag), nickel (Ni), tin (Sn), zinc (Zn), or gold (Au).

20. The method of claim 18, further comprising, prior to plating the pattern, curing the pattern, wherein curing comprises at least one of ultraviolet or e-beam curing.
